(19) United States
(12) Patent Application Publication
(10) Pub. No.: US 2009/0051642 A1
(43) Pub. Date: Feb. 26, 2009

(54) Backlight assembly, method of driving the same and display system having the same thereof

(75) Inventors: Danding Huang, Tai Kok Tsui (HK); Wei Zhang, Clear Water Bay (HK); Shou Lung Chen, Ma On Shan (HK); Huajun Peng, Tai Po (HK); Chen-Jung Tsai, Judung (TW); Ying Liu, Hung Hum (HK); Pak Hong Ng, Ngau Chi Wan (HK)

Correspondence Address: MERCHANT & GOULD PC, P.O. BOX 2903, MINNEAPOLIS, MN, 55402-0903, US

(73) Assignee: Hong Kong Applied Science and Technology Research Institute Co. Ltd., Shatin (CN)

(21) Appl. No.: 11/895,177

(22) Filed: Aug. 23, 2007

(51) Int. Cl. G09G 3/36

(52) U.S. Cl. 345/102

(57) ABSTRACT

The present invention provides a backlight assembly and a display system having the same, characterized in that the backlight assembly comprises: a plurality of light emission units and a control unit. Each unit having M kinds of emission components, each of the M kinds of emission components emitting light of a spectrum which is different from each other, wherein M is a positive integer equal to or greater than two. The control unit receives a first signal and determines a second signal according to the color information of the first signal, and individually controls light emission of each emission component of the plurality of light emission units based on the second signal, wherein the light emissions from the plurality of light emission units generate a spatially-dependent spectrum distribution, and the light emission of each light emission unit forms a color gamut in a color space which is individually different from others.

### FIELD OF THE INVENTION

The present invention relates to a backlight assembly, more particularly to a backlight assembly capable of enlarging color reproduction range and method of driving the same.

### DESCRIPTION OF THE PRIOR ART

An interface, such as a display, plays a core role between a user and the environment in which enormous information are dealt with at high speed. Particularly, a flat panel display, which is slender, power saving, radiationless as well as compatible to manufacturing process of semiconductor, gradually occupies an important position in connecting a user and the above-mentioned environment. A flat panel display could be applied to diverse fields, such as consumer electronic products, personal mobile electronic products, medical instruments, and exploitation facilities, etc.

In the conventional liquid crystal display, color reproduction is achieved by the cooperation of the following components: cold cathode fluorescent lamp (CCFL), which provides white light as a backlight source, three-color color filter of the LCD and optical valve control of liquid crystal molecules. Color reproduction range depends on quality factors of backlight assembly, filters and display panel. Due to the limited properties of the material forming CCFL and color filter, the color gamut of most LCD TV on market is normally around 75% NTSC. In order to increase the chromaticity range of the reproduction of the display, a well-known design for manufacturers is a CCFL made of improved phosphors, such that the emission of the CCFL covers a larger color gamut. However, the cost of backlight assembly in the above design increases but lifetime and efficiency of the CCFL decrease; besides, the increase of color gamut is limitary which does not fulfill the requirement of the consumer. As compared to traditional backlight sources, backlight systems composed of Red, Green and Blue (RGB) light emitting diodes (LED) have high-saturated color that makes LCD generate 100% NTSC color gamut.

It is noteworthy that a great NTSC ratio is not equivalent to good color reproduction. Meanwhile, both yellow-orange and cyan cannot be well reproduced simultaneously since a trade-off exists in a triangular color gamut. A polygonal color gamut overcomes such defect. Take Pointer's gamut for example, which is one of the standards established for representing colors appeared in the real world, the range covered thereby is similar to a quadrilateral. FIG. 4 shows a comparison between traditional CCFL gamut, LED gamut with reference of NTSC standard and Pointer's gamut in a CIE color space. Suppose that if a display could actually display all the colors in nature, the color gamut thereof should be a polygon. Some of the LCD manufacturers have devised several kinds of wide-gamut displays.

A popular design of changing the material of the color filters of one pixel on the display panel is utilized to create new color filters (sub-pixels) based on in the conventional RGB color filter array to obtain a polygonal color gamut, for example, yellow or cyan filters can be added thereto. Disadvantageously, the resolution of the above design decreases, moreover, the improved filter material, special sub-pixel structure and the consequent new driving/control system enormously increases expense on manufacturing flat panel displays, which are therefore uncompetitive.

Another design that provides two sets of RGB LED in the backlight assembly is also well-known in the market, by a sequential driving manner, the reproduction chromaticity range is enlarged. Nevertheless, the increased amount of driving circuits is consequent on two sets of LED. Moreover, the liquid crystal material must be chosen to respond quickly. Consequently, the cost of manufacturing such kind of backlight assembly grows significantly because the requirement of extra components and special liquid crystal material.

Given the above, flat panel displays in the marketplace have following disadvantages: insufficient color reproduction range, high power consumption as well as high manufacturing cost. Hence, a flat panel display having the advantages of broad color reproduction range, power saving as well as low manufacturing cost is desired on the market.

### SUMMARY OF THE INVENTION

To overcome the above defects exist in the flat panel displays on the market, the present invention provides a backlight assembly, which makes a flat panel display achieve broad color reproduction range, and method of driving the same. A flat panel display that comprises the above backlight assembly advantageously covers broader color gamut, saves power consumption and reduces the unnecessary manufacturing cost.

An embodiment of the present invention provides a backlight assembly for a color image display panel, comprising: a plurality of light emission units, each unit having M kinds of emission components, each of the M kinds of emission components emitting light of a spectrum which is different from each other, wherein M is a positive integer equal to or greater than two; and a control unit receiving a first signal and determining a second signal according to the color information of the first signal, and individually controlling light emission of each emission component of the plurality of light emission units based on the second signal, wherein the light emissions from the plurality of light emission units generate a spatially-dependent spectrum distribution, and the light emission of each light emission unit forms a color gamut in a color space which is individually different from others.

In a preferable embodiment, color gamut of light emission of each light emission unit is formed dynamically according to frames of the first signal, so that light emission of the plurality of light emission units form globally a polygonal color gamut in a color space.

In a preferable embodiment, the emission component emits light of multiple colors, wherein light intensity of each color is individually controlled.

Another embodiment of the present invention provides a display system, comprising: a display panel; a backlight assembly comprising a plurality of light emission units, each light emission unit having M kinds of emission components, each of the M kinds of emission components emitting light of a spectrum which is different from each other, wherein M is a positive integer equal to or greater than two; and a control unit being operative to: receive a first signal; determine a second signal according to color information of the first signal; control individually light emission of the emission components of plurality of light emission units based on the second signal, wherein light emissions from the plurality of light emission units have a spatially-dependent spectrum distribution, and light emission of each light emission unit forms a color gamut in a color space which is individually different from others; determine an image signal applying to the display panel.

In a preferable embodiment, the image signal applied to the display panel is provided according to the first signal and a light emission result of the plurality of light emission units, wherein the light emission result of the plurality of light emission units is one of the spatially-dependent spectrum distributions generated by the plurality of light emission units.

In another embodiment, color gamut of light emission of each light emission unit is formed dynamically according to frames of the first signal, so that light emission of the plurality of light emission units form globally a polygonal color gamut in a color space.

In a preferable embodiment, the emission component emits light of multiple colors, wherein light intensity of each color is individually controlled.

Another embodiment of the present invention provides a method of displaying an colored image on a display system having a display panel and a backlight assembly, wherein the backlight assembly comprises a plurality of light emission units, each light emission unit having M kinds of emission components, each of the M kinds of emission components emitting light of a spectrum which is different from each other, wherein M is a positive integer equal to or greater than two, the method comprising: receiving a first signal; determining a second signal according to color information of the first signal; and controlling individually light emission of the emission components of the plurality of light emission units based on the second signal, wherein the light emissions from the plurality of light emission units have a spatially-dependent spectrum distribution, and the light emission of each light emission unit forms a color gamut in a color space which is individually different from others.

In a preferable embodiment, an image signal is provided to the display panel, wherein the image signal is provided according to the first signal and a light emission result of the plurality of light emission units, wherein the light emission result of the plurality of light emission units is one of the spatially-dependent spectrum distributions generated by the plurality of light emission units.

In another embodiment, the color gamut of light emission of each light emission unit is formed dynamically according to frames of the first signal, so that light emission of the plurality of light emission units form globally a polygonal color gamut in a color space.

The flat panel display according to the present invention has the following advantages: the backlight assembly needs neither extra driving circuits nor the special phosphor material; the display panel is commercial type and needs neither special filter material nor particular sub-pixel structure; the light emitted from the backlight assembly has a spatially-dependent spectrum distribution, such that the display of the flat panel covers a larger color gamut for increasing the range of color reproduction. Therefore, the cost of flat panel display of the present invention is not increased much comparing to traditional flat panel displays. Moreover, the backlight assembly of the present invention is not sequentially driven and therefore can save more power as compared to the display with sequential-driving backlight assembly.

Other objectives and achievements of the present invention could be realized with reference to the following description of the present invention and claims as well as the accompanied drawings.

### BRIEF DESCRIPTION OF THE DRAWINGS

FIG. 1A shows a light emission unit in a backlight assembly according to an exemplary embodiment of the present invention;

FIG. 1B shows a light emission unit in a backlight assembly according to another exemplary embodiment of the present invention;

FIG. 1C shows a light emission unit in a backlight assembly according to another exemplary embodiment of the present invention;

FIG. 1D shows a light emission unit in a backlight assembly according to another exemplary embodiment of the present invention;

FIG. 2 is a schematic diagram of a flat panel display adopting the backlight assembly of the present invention; and

FIG. 3 is a flow chart that illustrates a method of driving the light emission unit in the backlight assembly in FIG. 1.

FIG. 4 illustrates a comparison of color gamut from a traditional CCFL backlit display and a LED backlit display, with reference of NTSC gamut standard and Pointer's gamut.

### DETAILED DESCRIPTION

The following embodiments of the present invention would be employed to illustrate the technical scheme of the present invention.

In one embodiment, the backlight assembly of the present invention comprises a plurality of light emission units, each of the plurality of light emission units corresponds to a display area of a display panel and has M kinds of emission components. Each of the M kinds of emission components emits light of a spectrum which is different from each other, wherein M is a positive integer equal to or greater than two.

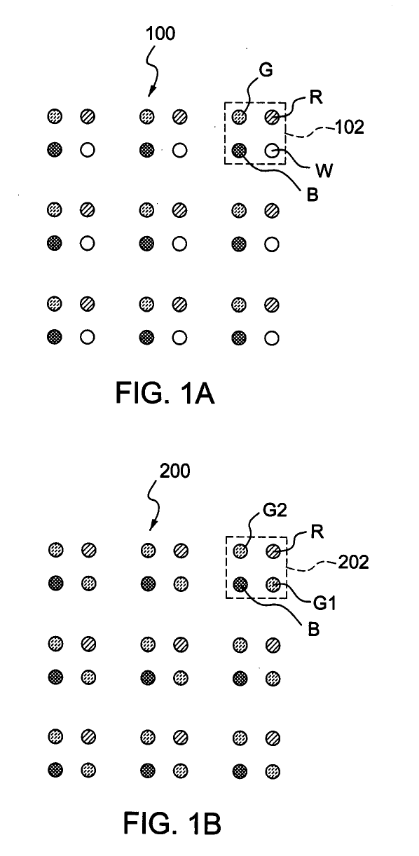

Referring to FIG. 1A, in this embodiment, the backlight assembly 100 comprises a plurality of light emission units 102, each of the plurality of light emission units 102 comprises four kinds of emission components which could be light emitting diodes of different colors, such as red light emitting diodes (hereinafter referred to as R), green light emitting diodes (hereinafter referred to as G), blue light emitting diodes (hereinafter referred to as B) and light emitting diodes with colors different from the above. For example, white, yellow, cyan or magenta (in this embodiment white light emitting diodes are adopted, hereinafter referred to as W).

Referring to FIG. 1B, in this embodiment, the backlight assembly 200 comprises a plurality of light emission units 202, each of the plurality of light emission units 202 comprises four kinds of emission components which respectively emits light of different wavelengths, wherein a color light (green light is used in this embodiment) represented by two wavelengths is different from the other two colors represented by the other two wavelengths (blue and red are used in this embodiment, respectively). The emission components could be light emitting diodes of different colors, such as red light emitting diodes (hereinafter referred to as R), green light emitting diodes (hereinafter referred to as G1 and G2 to differentiate different wavelengths), blue light emitting diodes (hereinafter referred to as B).

Referring to FIG. 1C, in this embodiment, the backlight assembly 300 comprises a plurality of light emission units 302, each of the plurality of light emission units 302 comprises M kinds of emission components capable of emitting P groups of red, green and blue light, wherein P is a positive integer equal to or greater than two and, all the wavelengths representing one color are different from each other. In the embodiment shown in FIG. 1C, light emission units 302 can emit 2 groups of red, green and blue light. The emission components can be light emitting diodes of different colors, such as red light emitting diodes (hereinafter referred to as R1 and R2 to differentiate different wavelengths), green light emitting diodes (hereinafter referred to as G1 and G2 to differentiate different wavelengths), blue light emitting diodes (hereinafter referred to as B1 and B2 to differentiate different wavelengths).

Referring to FIG. 1D, in this embodiment, the backlight assembly 400 comprises a plurality of light emission units 402, each of the plurality of light emission units 402 comprises two kinds of emission components, which could be a multi-color emission component and a single-color emission component. In one embodiment, two kinds of emission components can emit white light and light of any color rather than white. In this embodiment, the emission components could be white light emitting diodes (hereinafter referred to as W) and another light emitting diodes of a color rather white, such as red light emitting diodes (hereinafter referred to as R), green light emitting diodes (hereinafter referred to as G), blue light emitting diodes (hereinafter referred to as B). In another embodiment, the multi-color emission components can emit light of a plurality of colors that can be controlled independently, such as laser diodes, organic light emitting diodes, etc.

In addition to light emission units 102-402, the backlight assembly 100-400 shown in FIGS. 1A-1D further comprises a control unit (not shown in the drawings) which couples to the plurality of light emission units 102-402. In this embodiment, the control unit receives a first signal (such as a video signal or an image signal) and determines a second signal according to the color information of the first signal, and drives light-emission of the M kinds of emission components based on the second signal. In one embodiment, the color information of the first signal represented can be a datum relates to the chromaticity characteristic of an image to be displayed, and such chromatic characteristic can be represented by color coordinate in a chromaticity diagram, R/G/B averaging value, average hue value, u′v′ value, or color histogram value. In one embodiment, the control unit determines the second signal according to the color information of the first signal. The second signal determines light emission of each light emission unit by controlling light intensities of the M kinds of emission components so as to adjust light mixing ratio between the M kinds of emission components and to form a spatially-dependent spectral distribution. In other words, the present invention provides backlight having corresponding spectrum to the color of the image to be displayed at a corresponding position and thus the image color reproduction is improved.

Given by FIGS. 1A-1D, while driving the backlight assembly 100-400 by the second signal, the spectrum of the light emission from the M kinds of emission components has at least four different wavelength peaks. From the viewpoint of image display technology, it means that light emitted from the M kinds of emission components according to color information of the spatial signal, which adjusts the spectrum distribution provided thereto, covers a broader color gamut, rendering high image color reproduction.

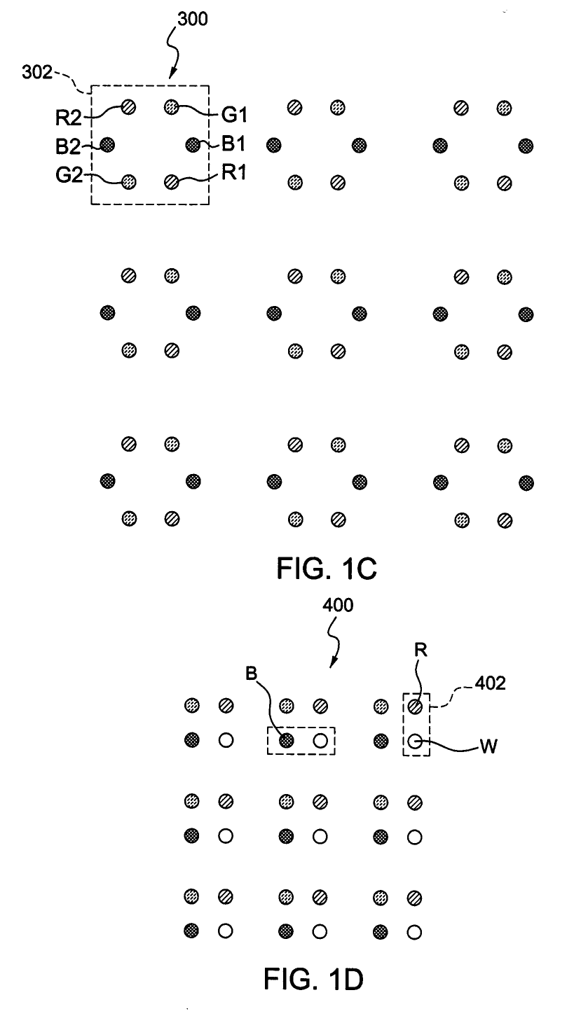

Referring to FIG. 2, which illustrates a flat panel display 500 according to an exemplary embodiment of the present invention. The flat panel display 500 comprises a backlight assembly 520, a display panel 530 (such as a liquid crystal display panel) and a control unit 510. In this embodiment, the backlight assembly 100-400 shown in FIGS. 1A-1D can be applied to the backlight assembly 520, but not limited to these applications. In this embodiment, the control unit 510 couples to the display panel 530 and the backlight assembly 520 and receives an input signal 61 (such as a video signal or an image signal). The control unit 510 determines an emission component control signal 62 according to color information of the input signal 61; then controls light-emission of the M kinds of emission components based on the emission component control signal 62; the control unit 510 determines a display panel control signal 63 according to the input signal 61 to drive the display panel 530, that is to say, the control unit drives the flat panel display according to the emission results of the M kinds of emission components and the display panel control signal.

In another embodiment of the present invention, the display panel 530 comprises N color filter elements (not shown in the drawings) having bands different from each other for passing through light of different wavelengths, wherein N is a positive integer equal to or greater than three. The spectrums of light emitted from the plurality of light emission units are independent of each other, so light emission from the plurality of light emission units has a spatially-dependent spectrum distribution, and hence form globally a polygonal color gamut of the backlight assembly. In another embodiment, the light emission results of the M kinds of emission components are 1 or light emission distribution of the M kinds of emission components.

Take FIG. 1B for example, a LCD is composed of conventional RGB color filters (or sub-pixels), and the backlight assembly is composed of LEDs of R, G1, G2 and B colors, wherein the wavelengths of G1 and G2 represent blue-green and yellow-green and both of them can pass through green filter. After a frame video signal (the first signal) is input, the control system divides the first signal into a plurality of areas from which the color information thereof is extracted. The color information can be a color coordinate value in a chromatic diagram, R/G/B averaging value, average hue value, Yu′v′ value, or color histogram value, etc. The color information is used to determine a second signal for driving LEDs in each light emission unit to emit light. In this embodiment, if a certain area shows yellow-green leaves, the second signal enhances the brightness of the yellow-green LEDs in the corresponding light emission unit set in this area; if the area shows blue-green lake water, the second signal enhances the brightness of the blue-green LEDs in the corresponding light emission unit set in this area. Accordingly, all the light emitted from the backlight assembly has spectrums blended with wavelengths and the light is determined by the first signal of the corresponding area. The above LEDs provide spectrum distributions varied dependently from spatial change and therefore make the display system a globally polygonal color gamut.

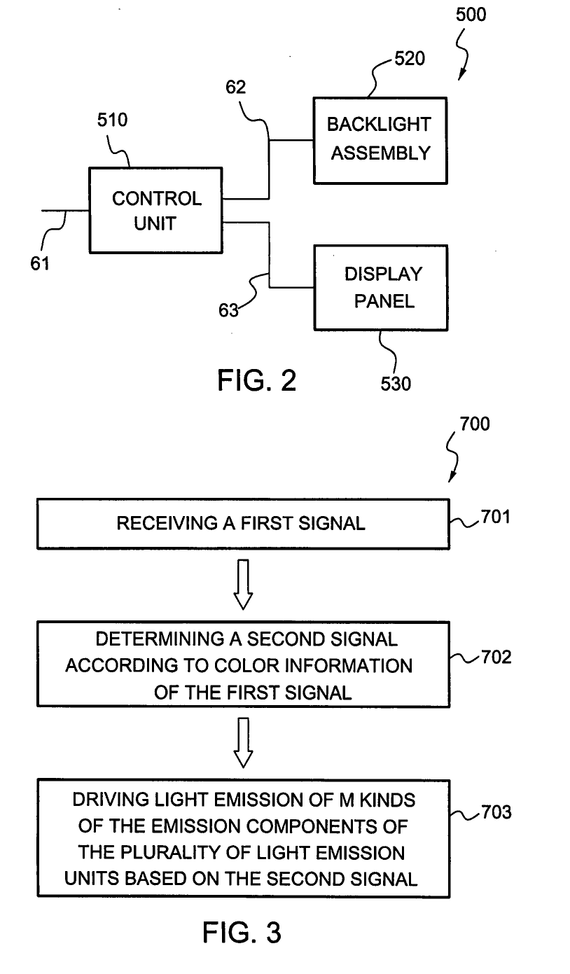

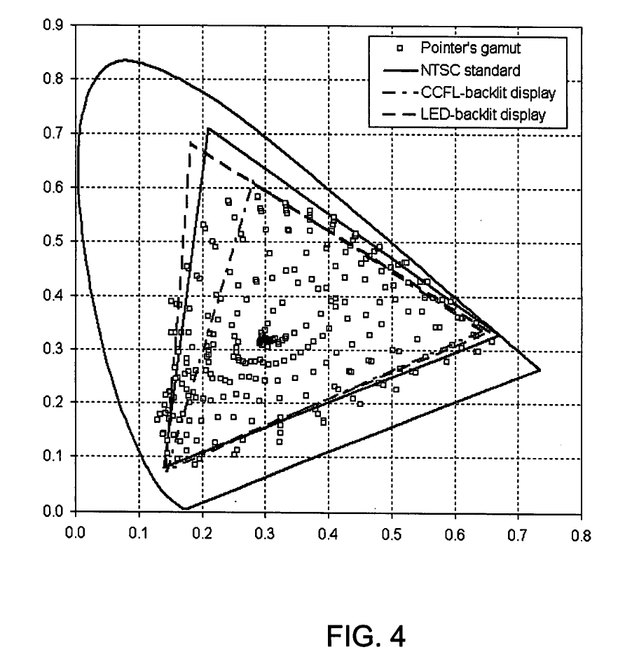

FIG. 3 illustrates a driving method 700 according to an exemplary embodiment of the present invention, the method 700 can drive the backlight assembly 100-400 shown in FIGS. 1A-1D according to the following steps:

Step 701: receiving a first signal;

Step 702: determining a second signal according to color information of the first signal; and

Step 703: driving light emission of M kinds of the emission components of the plurality of light emission units based on the second signal.

In this manner, spectrums of light emitted from the plurality of light emission units are independent of each other, so light emission from the plurality of light emission units has a spatially-dependent spectrum distribution, and hence form globally a polygonal color gamut of the backlight assembly.

In another embodiment of the present invention, the driving method 700 further comprises step 702′ (not shown in the drawings): the second signal determining each light emission unit by individually controlling light intensity of the M kinds of emission components so as to form a spatially-dependent spectral distribution.

In light of the above, the backlight assembly or flat panel display provided by the present invention has at least the following advantages: The light emitted from the backlight assembly of the present invention covers a larger polygon color gamut for increasing the range of color reproduction in flat panel display. Therefore, the cost of flat panel display with the backlight assembly is not increased much comparing to traditional flat panel display.

The technical content and features of the present invention are described above, however, those skilled in the art can make various modifications and variations without departing from the teaching and disclosure of the present invention. In view of the foregoing, the scope of the present invention is not limited to the disclosed embodiments, but covers other modifications and variations of the present invention that fall within the scope of the following claims.

1. A method of displaying an colored image on a display system having a display panel and a backlight assembly, wherein the backlight assembly comprises a plurality of light emission units, each light emission unit having M kinds of emission components, each of the M kinds of emission components emitting light of a spectrum which is different from each other, wherein M is a positive integer equal to or greater than two, the method comprising:
receiving a first signal;
determining a second signal according to color information of the first signal; and
controlling individually light emission of the emission components of the plurality of light emission units based on the second signal,
wherein the light emissions from the plurality of light emission units have a spatially-dependent spectrum distribution, and the light emission of each light emission unit forms a color gamut in a color space which is individually different from others.

2. The method as claimed in claim 1, wherein while the M kinds of emission components are driven by the second signal, the spectrum of the light emission from the M kinds of emission components has at least four different peak wavelengths.

3. The method as claimed in claim 1, wherein the color information of the first signal represents a chromatic characteristic.

4. The method as claimed in claim 1, wherein the second signal determines light emission of each light emission unit and individually controls light intensities of the M kinds of emission components so as to adjust light mixing ratio between the M kinds of emission components and to form a spatially-dependent spectral distribution.

5. The method as claimed in claim 3, wherein the chromatic characteristic is extracted from a group including color coordinate in a chromaticity diagram, R/G/B value, HSL value, Yu′v′ value, color histogram value of the first signal.

6. The method as claimed in claim 1, wherein an image signal is provided to the display panel, wherein the image signal is provided according to the first signal and a light emission result of the plurality of light emission units, wherein the light emission result of the plurality of light emission units is one of the spatially-dependent spectrum distributions generated by the plurality of light emission units.

7. The method as claimed in claim 1, wherein the first signal is a video signal or an image signal.

8. The method as claimed in claim 1, wherein while M is two, one of the M kinds of emission components emits white light, and the other one of the M kinds of emission components emits light of any color rather than white.

9. The method as claimed in claim 1, wherein while M is four, the M kinds of emission components emit light of a first color, red light, green light, and blue light, respectively.

10. The method as claimed in claim 9, wherein the light of the first color is white, yellow, cyan, magenta or another kind of red light, green light or blue light having a spectrum different from that of the red light, green light or blue light.

11. The method as claimed in claim 1, wherein color gamut of light emission of each light emission unit is formed dynamically according to frames of the first signal, so that light emission of the plurality of light emission units form globally a polygonal color gamut in a color space.

12. The method as claimed in claim 1, wherein the M kinds of emission components emit P groups of light, each group comprising one red light, one green light and one blue light, wherein P is a positive integer equal to or greater than two and, all the spectrums representing one color are different from each other.

13. A display system, comprising:
a display panel;
a backlight assembly comprising a plurality of light emission units, each light emission unit having M kinds of emission components, each of the M kinds of emission components emitting light of a spectrum which is different from each other, wherein M is a positive integer equal to or greater than two; and
a control unit being operative to:
receive a first signal;
determine a second signal according to color information of the first signal;
control individually light emission of the emission components of plurality of light emission units based on the second signal,
wherein light emissions from the plurality of light emission units have a spatially-dependent spectrum distribution, and light emission of each light emission unit forms a color gamut in a color space which is individually different from others;
determine an image signal applying to the display panel.

14. The display system as claimed in claim 13, wherein while the M kinds of emission components are driven by the second signal, the spectrum of the light emission has at least four different peak wavelengths.

15. The display system as claimed in claim 13, wherein the display panel further comprises N color filter elements having bands different from each other, wherein N is a positive integer equal to or greater than three.

16. The display system as claimed in claim 13, wherein the color information of the first signal represents a chromatic characteristic.

17. The display system as claimed in claim 13, wherein the second signal determines light emission of each light emission unit and is used to individually control light intensities of the M kinds of emission components so as to adjust light mixing ratio between the M kinds of emission components and to form a spatially-dependent spectral distribution.

18. The display system as claimed in claim 17, wherein the chromatic characteristic is extracted from a group including color coordinate in a chromaticity diagram, R/G/B value, HSL value, Yu′v′ value, color histogram value of the first signal.

19. The display system as claimed in claim 13, wherein the image signal applied to the display panel is provided according to the first signal and a light emission result of the plurality of light emission units, wherein the light emission result of the plurality of light emission units is one of the spatially-dependent spectrum distributions generated by the plurality of light emission units.

20. The display system as claimed in claim 13, wherein the first signal is a video signal or an image signal and the display panel is a liquid crystal display panel.

21. The display system as claimed in claim 13, wherein while M is two, one of the M kinds of emission components emits white light, and the other one of the M kinds of emission components emits light of any color rather than white.

22. The display system as claimed in claim 13, wherein that while M is four, the M kinds of emission components emit light of a first color, red light, green light and blue light, respectively.

23. The display system as claimed in claim 22, wherein the first color is white, yellow, cyan, magenta or another kind of red light, green light or blue light having a spectrum different from that of the red light, green light or blue light.

24. The display system as claimed in claim 13, wherein color gamut of light emission of each light emission unit is formed dynamically according to frames of the first signal, so that light emission of the plurality of light emission units form globally a polygonal color gamut in a color space.

25. The display system as claimed in claim 13, wherein the emission component emits light of multiple colors, wherein light intensity of each color is individually controlled.

26. The display system as claimed in claim 13, wherein the M kinds of emission components radiate P groups of red, green and blue light, each group comprising one red light, one green light and one blue light, wherein P is a positive integer equal to or greater than two and, all the spectrums representing one color are different from each other.

27. A backlight assembly for a color image display panel, comprising:
a plurality of light emission units, each unit having M kinds of emission components, each of the M kinds of emission components emitting light of a spectrum which is different from each other, wherein M is a positive integer equal to or greater than two; and
a control unit receiving a first signal and determining a second signal according to the color information of the first signal, and individually controlling light emission of each emission component of the plurality of light emission units based on the second signal,
wherein the light emissions from the plurality of light emission units generate a spatially-dependent spectrum distribution, and the light emission of each light emission unit forms a color gamut in a color space which is individually different from others.

28. The backlight assembly as claimed in claim 27, wherein while the M kinds of emission components are driven by the second signal, the spectrum of the light emission has at least four different peak wavelengths.

29. The backlight assembly as claimed in claim 27, wherein the color information of the first signal represents a chromatic characteristic.

30. The backlight assembly as claimed in claim 27, wherein the second signal determines light emissions of the plurality of light emission units and is used to individually control light intensity of each light emission component so as to adjust light mixing ratio between the M kinds of emission components and to form a spatially-dependent spectral distribution.

31. The backlight assembly as claimed in claim 29, wherein the chromatic characteristic is extracted from a group including color coordinate in a chromaticity diagram, R/G/B value, HSL value, Yu′v′ value, color histogram value of the first signal.

32. The backlight assembly as claimed in claim 27, wherein the first signal is a video signal or an image signal.

33. The backlight assembly as claimed in claim 27, wherein while M is two, one of the M kinds of emission components emits white light, and the other one of the M kinds of emission components emits light of any color rather than white.

34. The backlight assembly as claimed in claim 27, wherein while M is four, the M kinds of emission components emit light of a first color, red light, green light and blue light, respectively.

35. The backlight assembly as claimed in claim 34, wherein the first color is white, yellow, cyan, magenta or another kind of red light, green light or blue light having a spectrum different from that of the red light, green light or blue light.

36. The backlight assembly as claimed in claim 27, wherein color gamut of light emission of each light emission unit is formed dynamically according to frames of the first signal, so that light emission of the plurality of light emission units form globally a polygonal color gamut in a color space.

37. The backlight assembly as claimed in claim 27, wherein the emission component emits light of multiple colors, wherein light intensity of each color is individually controlled.

38. The backlight assembly as claimed in claim 27, wherein the M kinds of emission components emit P groups of red, green and blue light, each group comprising one red light, one green light and one blue light, wherein P is a positive integer equal to or greater than two and, all the spectrums representing one color are different from each other.
